(19) United States
(12) Patent Application Publication
(10) Pub. No.: US 2011/0231384 A1
(43) Pub. Date: Sep. 22, 2011

(54) EVOLUTIONARY TAGGER

(75) Inventors: MAKSIM KOROTEYEV, BROOKLYN, NY (US); VLADIMIR KOROTEYEV, Brooklyn, NY (US); OLEKSANDR PASICHNYK, Kiev (UA)

(73) Assignee: EVTEXT, INC., Brooklyn, NY (US)

(21) Appl. No.: 12/634,627

(22) Filed: Dec. 9, 2009

(51) Int. Cl. G06F 17/30; G06N 3/12; G06F 15/18

(52) U.S. Cl. 707/709; 707/796; 707/793; 706/12

(57) ABSTRACT

The invention is a process, system, workflow system for data retrieval processes, software, Web Site, service and SaaS (Software as a Service) created to support a data retrieval process from various document types to custom or preset retrieval data structures. The program supports manual, automatic and semiautomatic data retrieval using its internal features or external add-ons. It links data points in the structure to the corresponding data points in the document, stores documents, structures and links between them and outputs results in various formats. Links between a document and a retrieval data structure are established either automatically or manually by the user. After all required links are set, results can be retrieved from the program as an XML (Extensible Markup Language) structure with required data or as a PDF (Portable Document Format) or HTML (Hypertext Format Language), in MS Office formats and others containing a/the retrieval data structure, the original document or both with links between corresponding data points.

The system incorporates a Text Mining engine, which provides automatic information retrieval capabilities. The engine implements Text mining technology that is based on Evolutionary Bayesian Ontology Classification. This technology uses Bayesian Ontology for modeling the problem's domain and applies Evolutionary Search for the most plausible classification decision.

The ability to learn from data is a key feature of Bayesian Ontology, and for our embodiment. The complexity and size of semantic and format dependencies between elements in a natural language text is too high for analytical descriptions. Plus, we intend to save the user the trouble of building their own data retrieval models. Instead, we rely on an algorithm that automatically links user's data selections to the closest categories in pre-built ontologies and generates selection specific classifiers. Every individual ontology keeps learning from user corrections during its life cycle. The system is specifically built with the ability to accumulate data models learned from various types of documents. The more documents have been processed by the system, the higher generalization capabilities it possesses for automatic processing of new, unseen documents.

### FIELD OF INVENTION

The present invention relates generally to data retrieval from documents, converting unstructured information sources into retrieval data structures by means of building semantic ontologies and machine learning.

### DESCRIPTION OF PRIOR ART

This invention is in response to the high demand for a tool, which simplifies the data retrieval process from unstructured documents into semantic retrieval data structures. Such retrieval data structures are in high demand in many business fields where data is kept in unstructured digital documents and has to be used for reports, as data for other software applications, for validating data kept in the document, for archiving data or for making other types of documents based on the same data.

This product should simplify the overall data retrieval process by incorporating several features. These features are:
the ability to link data points between the retrieval data structure and the document
a data retrieval automation process and a self adjusting automation process which learns from user experience

Linking should simplify the overall search process for corresponding data during both the actual data retrieval process and the data validation process. Automation will save time, and either partially or completely eliminates the need for searching for hidden data in the document manually. Such a task can be a challenge, due to the possible complexity of the original document. The self adjustment-learning mechanism will learn and incorporate all the corrections and manual retrievals performed by the user. This way the user doesn't have to use and know Text Mining techniques and will not have to spend extra time on making adjustments to the way the system retrieves data. Machine learning based mechanisms will make the required corrections based on the user's updates and corrections.

What is unique about the invention is that it converts all documents stored in the system into HTML format. The process of conversion into HTML format is performed at the moment of the document's import into the system. Having an HTML in the system allows us to mark and store all retrieved data points in an HTML format copy of the original document (FIG. 7). Such integration of tags into the document simplifies the overall process of storing data and converting documents and structures into other document formats. Also, all data is stored in the database.

### BACKGROUND OF THE INVENTION

The invention is a process, system, workflow system for data retrieval processes, software, Web Site, service and SaaS (Software as a Service) created to support a data retrieval process from various document types to custom or preset retrieval data structures. The invention supports the user's data retrieval tasks by means of building semantic ontologies and machine learning. The user is intended to be less involved in the technical aspects of data retrieval techniques. The most fundamental tasks that can be done by the user are building or reusing a prebuilt retrieval data structure, linking data points in the document to the corresponding places in the retrieval data structure, validating data using linking and providing sets of calculations for specific document types, initiating automatic data retrieval, fixing results of automatic retrieval and helping the system to adjust its automation algorithms.

The following is a description of the general workflow. The top-level mockup of the process can be seen in FIG. 6. Once the document is placed into the system (the invention), it can be associated with one or more retrieval data structures, represented as a tree-like retrieval data structure. The document gets converted into HTML (See FIG. 1₍₂₎) and is stored in the system in HTML format. HTML keeps both documents and special tags pointing by the system into a HTML file. Such tags point to the location of data in the retrieval data structure (See FIG. 7).

The user has three options: either initiate an automatic retrieval process, do it manually, or a combination of both. The order in which manual and automatic retrieval processes can be initiated is indicated in FIG. 6. After the retrieval process is complete (See FIG. 1₍₅₎), the user can validate (See FIG. 1₍₁₁₎) data for specific document structures. Some specially preset document structures have specific sets of calculations, (See FIG. 1₍₉₎) helping the user in data validation. In the final step, the user can export (See FIG. 1₍₁₃₎) results into a specific data format. This can be an XML structure for retrieval data structure with retrieved data only, or it can be an MS Office document, PDF or HTML document containing both a document and retrieval data structure with links to each other's data points.

Availability of the preset template can change the order of the user's activities (FIG. 6). If the user uses a preset template (examples of such templates are XBRL, IFRS, other financial template e.t.c.), it gives the user the ability to use instant automation (See FIG. 1_{(8.4)}) that benefits them in full or partial completion of the retrieval, based on the quality of data provided by the user. The user can make corrections that will instantly be picked up by the system for self-learning purposes (See FIG. 1_{(8.2)}). Next time, when automation is initiated, the system will try to adapt to corrections made by the user and retrieve data in a new way. This is a very helpful process for a set of documents that are close to each other in formatting and location of data. If the user is building a completely new retrieval data structure, there is a chance that some generic data items (company names, dates) will be retrieved instantly. To increase a number of automated data points, the user has to perform data retrieval manually (See FIG. 1₍₅₎). There is a chance that it will require a manual retrieval from a set of several similar documents before it will teach the system retrieval data.

Validation (See FIG. 1₍₁₁₎) is another part of invention. It compares retrieved results with the results of calculations and shows the difference between them. Validation can be performed on the document and data structures retrieved by the invention, or can perform data validation for the document and data structure previously processed by another type of software, or manually. The user will have to import both the data structure and the document into the system.

The system provides the capability of automatic data retrieval from documents. It is based on a set of pre-built ontologies (See FIG. 1_{(8.4)}) for generic text categories and on the ability to learn from data (See FIG. 1_{(8.2)}). A user invests knowledge about the dependencies between the text objects every time he builds a template for their type of documents, manually tags data items or corrects results of automatic extraction. The system automatically links results of the user's data selections to the joint base of knowledge with the following actions:
Search for the covering categories in existing ontologies that will be used for inheritance
Search for semantically correlated categories that will be used as indicators
Automatic generation of selection specific classifiers
Automatic building of document type specific ontologies

### DESCRIPTION OF DRAWINGS

FIG. 1 A top level view of the system, one is a top level view and the other one is a detailed view

FIG. 2 A top level view of the application consisting of 3 windows: document repository, document structure viewer and editor and document viewer

FIG. 3 Document repository windows are places for storing client's documents (also see FIG. 1₍₃₎)

FIG. 4 Multi-tab retrieval data viewer is a place for viewing a list of all retrieval data structures and viewing the content of each data structure (also see FIG. 1₍₆₎)

FIG. 5 Multi-tab document viewer screen is a place for viewing the content of documents (also see FIG. 1₍₁₂₎)

FIG. 6 Flow chart indicating two different workflows, one for the preset document structure and another one for the document structure created by the user.

FIG. 7 Data point appearance in the document, in the retrieval document structure and in the document in HTML format.

FIG. 8 Retrieval document structure's appearance, the way it is shown in the document structure window. Consists of three parts: Contexts, Calculations and Presentation (also see FIG. 1₍₆₎)

FIG. 9 Sample of validation screen (also see FIG. 1₍₁₁₎)

FIG. 10 Exported document, the sample is in HTML format and it contains the retrieval document structure, document and validations (exported document generated by the Results Exporter in the FIG. 1₍₁₁₎)

FIG. 11 Example of bi-directional linking between the retrieval data structure and the document.

FIG. 12 Illustration of the representation of basic data structures (XBRL, IFRS, etc) in the

Retrieval Data Structure Window of the invention. (it can be located in FIG. 1_{(8.4)} of System Design)

FIG. 13 Illustration of the basic retrieval data structure. It contains presentation and calculation trees from the basic taxonomy's statement.

FIG. 14 Illustration of the upload of a document into the XBRL Data Mapping Builder. (see it in the FIG. 1₍₄₎)

FIG. 15 Illustration of the starting of automatic XBRL distribution (the actual mapping process)

FIG. 16 Illustrates results of automatic XBRL distribution—structure and retrieved document.

FIG. 17 Illustrates results of automatic XBRL/IFRS distribution—structure

FIG. 18 Demonstrates a fragment of ontology tree with built in category models

### DESCRIPTION OF THE PREFERRED EMBODIMENT

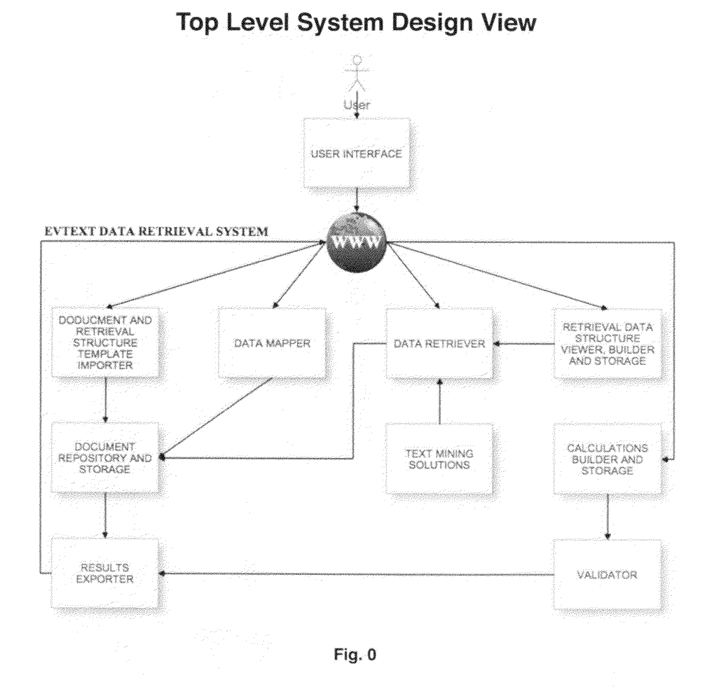

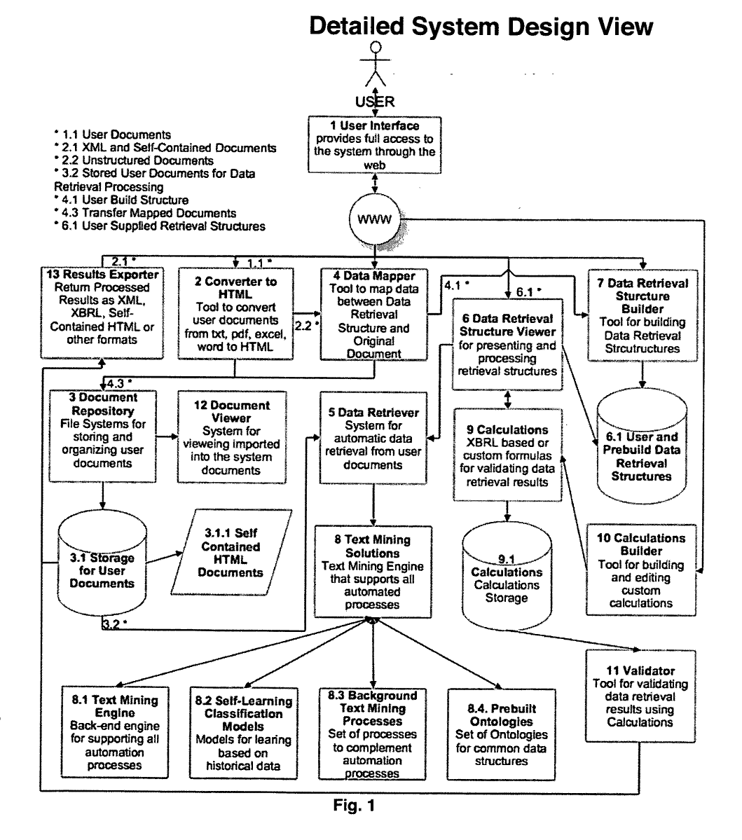

FIG. 1 The Data Retrieval System consists of 10 major elements.

User accesses the system through the web based User Interface (FIG. 1₍₁₎). User all tasks through the User Interface limited by permissions only. Permissions are a set of controls for limiting or expending access to certain features.

For a document to be processed, it should be imported into the system first. When the user activates an import feature in the user interface they are asked to locate a document on the local user's drive and import it into the system. During the import system it either just imports it if the document is in HTML format, or it converts it to HTML format if it is in any other supported formats. Conversion of the document happens in the Converter to HTML (FIG. 1₍₂₎).

The insertion process places documents into the Document Repository (FIG. 1₍₃₎) of the system. The Document Repository has features for document management, folder creation, and folder content management. Behind the Document Repository there is a storage area (FIG. 1_{(3.1)}) for keeping documents.

According to our design, user documents, after the insertion, become containers as well. They store the document content and all retrieved data from the document (FIG. 1_{(3.1)}) based on the retrieval data structure.

There are two major engines for document processing. One of them is a Data Mapper (FIG. 1₍₄₎), which automatically establishes links between user documents and pre-processed retrieval data structures imported with documents by the user. Another engine is a Data Retriever (FIG. 1₍₅₎). It retrieves data from user documents to the retrieval data structure's data points and stores them in the document. There are two types of data retrieval, one is manual and the other is automated.

The data retrieval process supported by the set of Text Mining solutions (FIG. 1₍₈₎) was invented and developed to support automated data retrieval.

The Text Mining Solutions consist of the Text Mining Engine (FIG. 1_{(8.1)}), a set of algorithms required for automating the data retrieval process. Self-Learning Classification Models (FIG. 1_{(8.2)}) are required for improving results of data retrieval based of adjustment made by the user.

A set of Background Processes (FIG. 1_{(8.3)}) used to improve the results of automatic data retrieval and add additional limitations or directions for Text Mining algorithms. Collections of Prebuilt Ontologies (FIG. 1_{(8.4)}) for specific data structure types are made for making the process of automatically retrieving into such ontologies less painful. User received automation, sets of calculations (FIG. 1₍₉₎) for specific types of documents.

Calculations (FIG. 1₍₉₎) are sets of formulas already preset or user generated for checking retrieved data against such formulas. Such formulas correspond to particular data points in the Retrieval Data Structures, the actual structure where data is retrieved to, and can be made of other retrieved values. It is assumed that calculated value should be equal to the value retrieved.

If not, it will be reflected in the Validator (FIG. 1₍₁₁₎), a special tool designed for checking formulas in the Calculations against the retrieved values. Formulas can be preset or they can be built by the user using the Calculations Builder (FIG. 1₍₁₀₎).

The retrieval process consists of the manual or automatic location of required data in the user's documents and posting them to the corresponding cells, the data points. Structured representation of retrieved data is called the Retrieval Data Structure (FIG. 1₍₇₎). Such structures exist preset or can be generated by the user in the Retrieval Data Structure Builder (FIG. 1₍₁₀₎). The Retrieval Data Structure Builder is a part of the Retrieval Data Structure Viewer (FIG. 1₍₉₎) used to view such structures or manage them during the retrieval process.

To receive results of data retrieval, the user has to use the Results Exporter (FIG. 1₍₁₃₎). It converts the results of data retrieval into an exported XML based document or it can generate a self-contained document. A self-contained document can be in HTML, PDF or MS Office format. It contains an original document, a data structure and validations. All three items are linked, so by clicking on the data point of either one, it will reveal the actual location of the data point in another two. This way, the user has the flexibility of either exporting an XML based document, which is hard to read but easier to reuse with other applications, or exporting a self contained document that easy to read, to review, and to present.

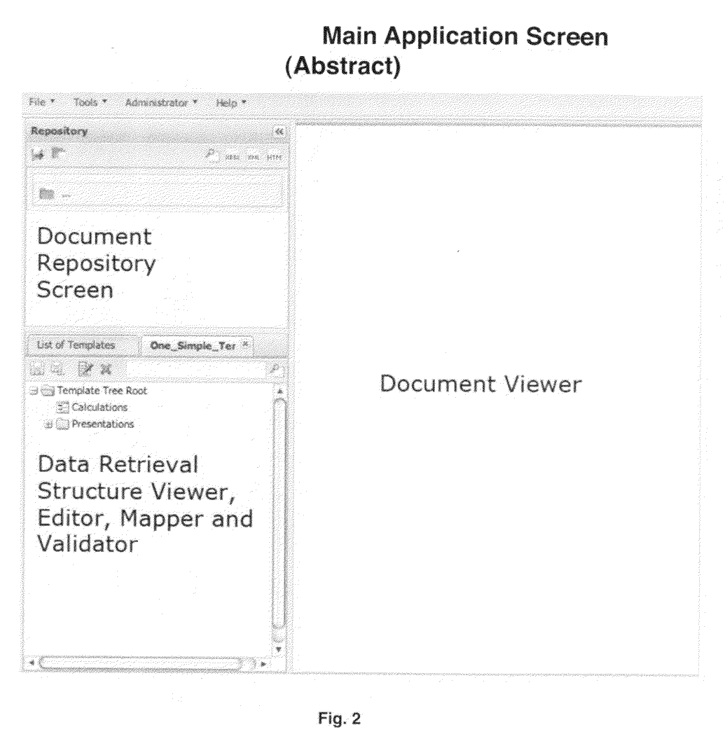

FIG. 2 This sketch shows the main screen of the application. The main screen is split into 3 windows: the document repository window (See FIG. 1₍₃₎), the retrieval data structure viewer (See FIG. 1₍₆₎) also containing the builder (See FIG. 1₍₇₎), mapper (See FIG. 1₍₄₎) and validator windows (See FIG. 1₍₁₁₎) and the document viewer window (See FIG. 1₍₁₂₎). All 3 windows are linked to each other in following ways:

The document repository (See FIG. 1₍₃₎) stores all documents imported into the system by the user. By selecting a specific document from the document repository, the context of the document will be opened in a separate tab of the document viewer. If there is a retrieval data structure associated with the document, it will be open in a separate a tab of the retrieval document structure viewer. If there is no document structure association set to the document, there will be no document structure open. The results of the data retrieval process are stored in the document opened from the document repository.

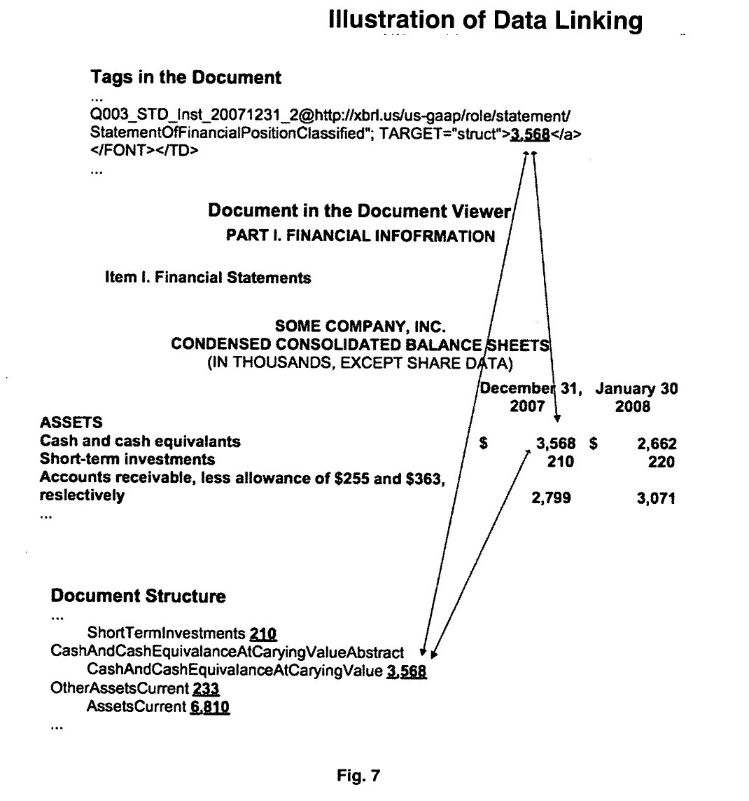

The retrieval document structure window has links between the document structure's data points and corresponding data points in the document (FIG. 7) When the user selects one of the data points in the document structure, the document viewer scrolls to the location of the data point in the document and indicates the linked item.

Data points in the document viewer are linked to data points in the retrieval document structure. When the user clicks on the “marked as retrieved” data point in the document, the retrieval document structure will scroll to the corresponding data point and indicate a data point value in

the document structure equal to the selected data point in the document.

The sketch doesn't show any additional add-ons, but some additional features are available to the user. Such features are, but not limited to:

The status bar—the panel on the bottom of the application indicating processes, connections to the server, documents in the repository counters and documents state indicators.

The main task-bar—the application menu containing administrative tools, user management tools and a set of general controls.
User Controls—the ability to manage users
Permissions Controls—the ability to control user permissions
Add-ons Management—the ability to control add-ons, and use their additional features available

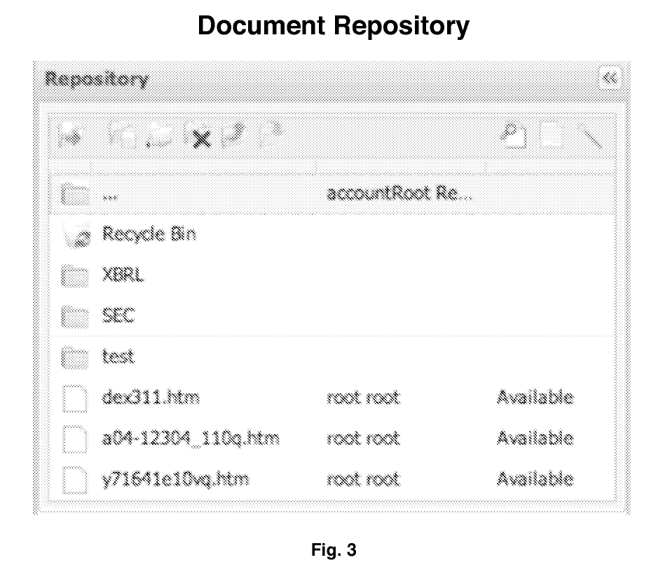

FIG. 3 The document repository indicates and helps to manage all documents imported into the system. Before any document can be retrieved using the invention, the document should be imported into the system by the user. There are two ways to initiate the import feature: one is from the repository task-bar on the top of the window or a second option is from the main task bar of the application. After the document is imported into the system it appears in the document repository. The user has the option to associate any template with a document during the import process or at any other time.

The user has the ability to associate any document with several data structures. During the import process, the user can choose several data structures to associate with. The result will be a set of identical documents in the repository, each associated with a unique data structure. If the user wants to associate any document in the document repository with a different data structure, they can do it using a clone option that creates a copy of the document. Such documents can be associated with a different data structure or left unassociated for later.

The user receives all the usual controls over the document repository like creating and deleting folders, moving files from one folder to another, renaming files and folders, copying and pasting documents and deleting. Also, it has a recycle bin that allows the restoration of files and folders after deletion.

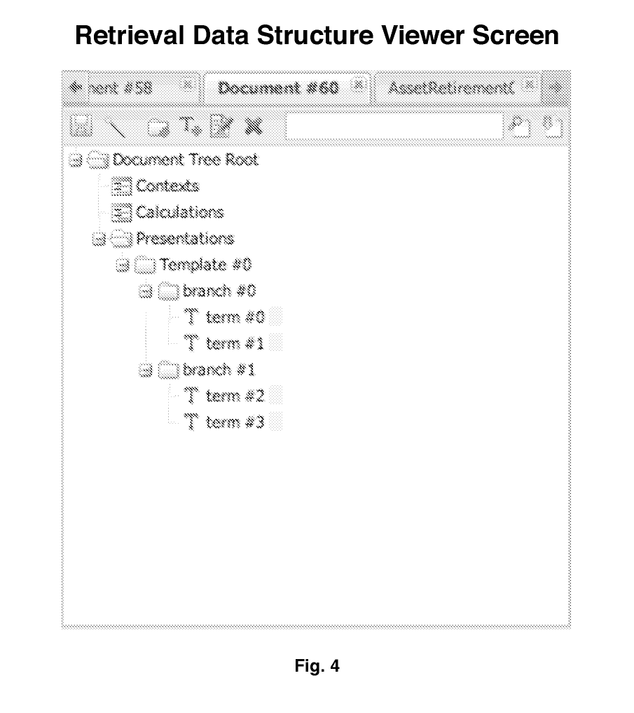

FIG. 4 The retrieval document structure window has multiple purposes. The window is controlled using multiple tabs. The first tab is used to show all available retrieval data structures to the user. By clicking on any data structure from the first tab, its structure is opened in the new tab. After that, the data structure can be edited, updated and mapped to the document.

Also, templates can be opened from the document repository. If the user selects a document from the document repository that already has a retrieval structure associated with it, the retrieval document structure associated with a document will be opened. Terms already retrieved from the document will appear in the structure. When users click on the data point in the document that already has a link to the corresponding data point in the retrieval document structure, the structure will scroll to the corresponding data point and show retrieved data.

The use of the document structure window is as a validation process. The user has the ability to describe calculations rules (See FIG. 1₍₁₀₎) linked to specific data points. Such calculations can link several data points into a single formula. If the number calculated is not equal to the number that was retrieved, it will indicate the difference to the user.

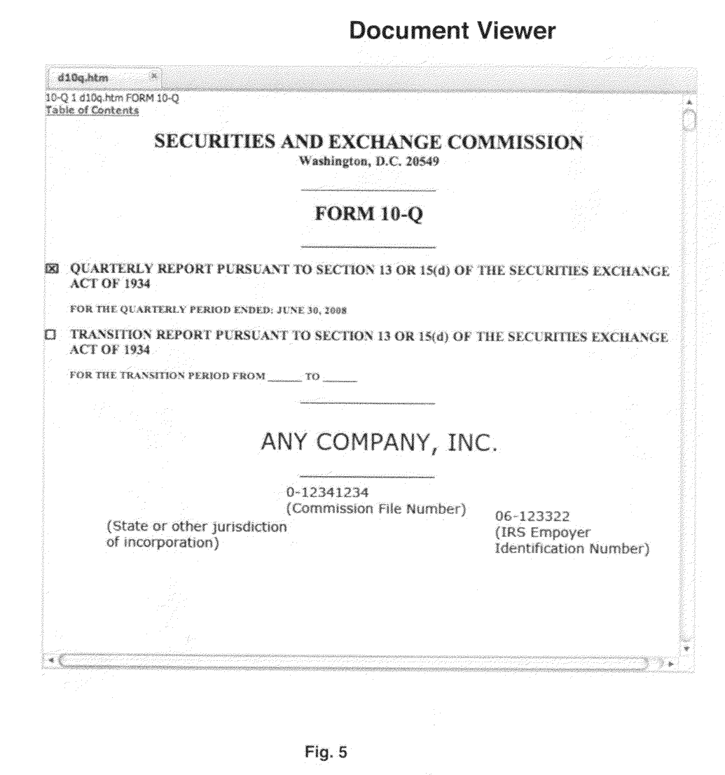

FIG. 5 The document view window is used to display the document's contents. It is a multi-tab window that allows switching between different documents. If the user selects a different document it will switch to the document template linked to this document as well.

All the retrieved data in the document is highlighted and is linked to the data point locations in the retrieval document structure. By selecting a marked data point in the structure, the user will be redirected to the location of data in the retrieval document structure.

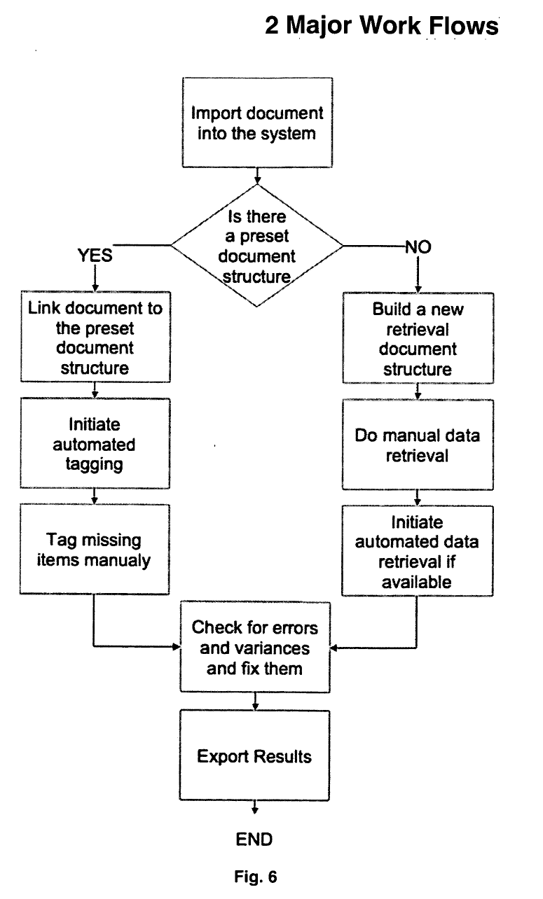

FIG. 6 There are two different process workflows:

1. The user builds a retrieval data structure from the ground up. An automation process is unavailable in the early stages in most cases. The only opportunity for the user to have automation in the early stage is to use already preset automation data points. Such data points can be dragged to the data structure from other previously preset structures.

After the data structure is created, the user is able to try the automation, but the best result is achieved by using only partial data retrieval. The user will have to perform the manual extraction at least for a single document or in most cases for a set of documents. This set of actions is required to collect all the patterns used to place data points into the document. This set of documents is called the teaching set. The number of documents in the teaching set varies for different data points. It depends on differences in the location of data points from document to document and on the complexity of documents.

After the data retrieval for the teaching set is complete, the user has the option to initiate an automation process. If the user doesn't rely on the quality of retrieved data, they can use a test set, a set of documents with already retrieved data and compare automation results of such documents with data previously retrieved. If the user relies on the results of automation, he can run automation for all selected documents and leave verification for later.

After data is retrieved, the system provides a verification process for it. Since the document structure used is built from scratch, verification rules have to be set by the user. The user can assign specific formulas that involve the retrieval structure's data points and are expected to be equal to the data point it is assigned to. If the expected value is different, the validation process will show the difference in red as a warning.

At the end of the process, the user has the option of exporting results into several different formats: MS Office formats, PDF, HTML and XML. All formats but XML store both the retrieval data structure and documents with bidirectional links between the corresponding data points.

2. The user selects one of the previously preset retrieval data structures. If there is a preset data structure, there is also a preset automation for a set of data points. It gives the user the ability to use the automation data retrieval instantly.

The next step is the validation and correction of automated retrieval results. The user has a preset validator that comes with a preset template. After finishing validation for a number of documents and restarting an automation process, the user should notice an improvement in results.

If results are unsatisfactory, the user can continue retrieving data manually and trying the automator to see if the system understands the corrections made.

All results can be exported into different formats like in the first workflow.

FIG. 7 User's documents get converted into an HTML format when they are imported into the system (See FIG. 1₍₂₎). The HTML used in the system is designed in such a way that it duplicates the retrieval results stored in the system's database (See FIG. 1_{(3.1)}).

The system places special tags that link a data point in the document to the corresponding data point in the retrieval data structure. It provides the ability to easily export all data to a document that contains and links both the retrieval data structure and the document. The document and a corresponding data structure all become self contained. There is no need for a database or any external tool for linking them to each other.

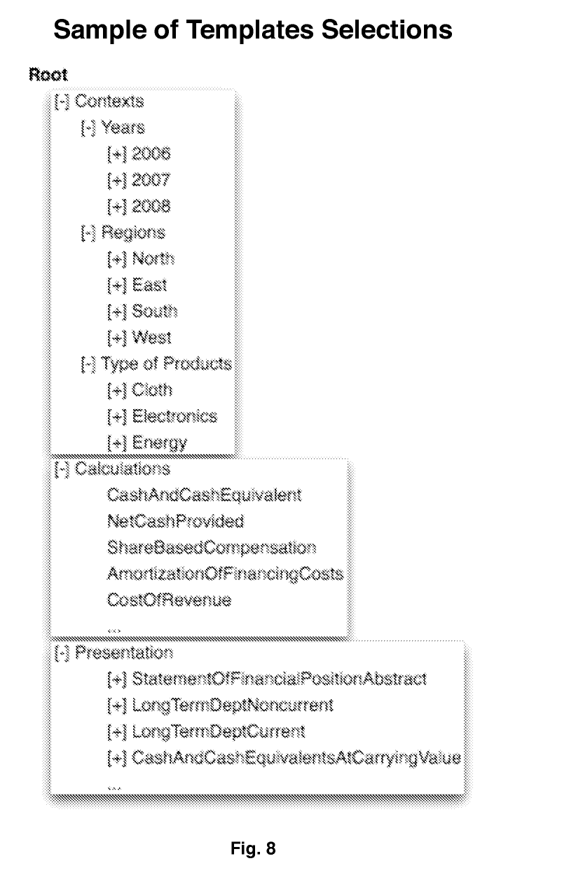

FIG. 8 The retrieval data structure is a part of a tree-like structure with 3 major branches. These branches are: contexts, calculations and presentations. The whole structure can be opened in the data structure window of the invention.

Detailed Description of the Major Branches:

Contexts—it allows the creation of groups of data. A set of data points in the retrieval data structure can be joined into groups by similar characteristics. For example, data points can be grouped by year, location, by the type of products they belong to, etc. It helps the user organize, locate and manage the retrieved data.

Calculations—is a utility for keeping and building all validation formulas. Such formulas can be preset, or the user can build them using a validation builder. All data points in the structure can have a validation formula assigned to it. The user will see if there any differences between the results calculated using the validator (See FIG. 1₍₁₁₎) and the originally retrieved data. The retrieved value can be fixed before the results are exported.

Presentation—is a retrieval data structure. It stores all retrieved data from the document. It consists of data points and groups of data points used to organize and store retrieved data. Each data point has a type (date, number, currency, text). If a data point is numeric, it can be a part of the calculation formula.

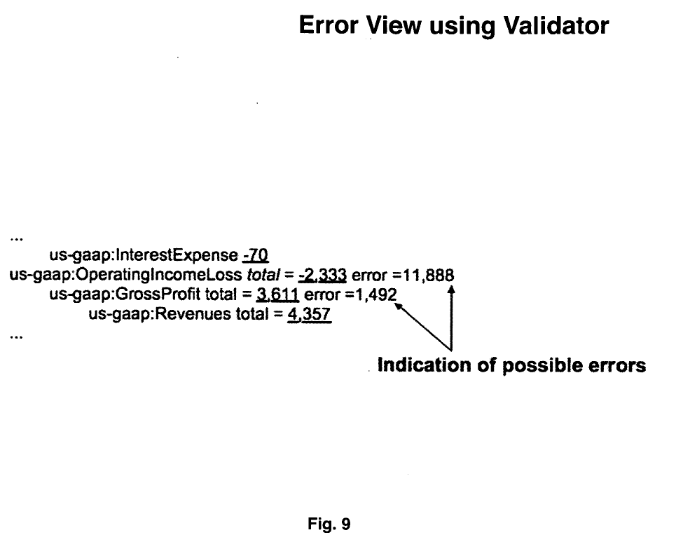

FIG. 9 The validation window (See FIG. 1₍₁₁₎) is a tool that helps a user to track possible retrieval errors. It uses formulas set in the calculations part of the data structure and compares them to retrieved data. If there is a calculation set for a specific data point and the result of the calculation is equal to the retrieved data, it doesn't indicate anything. If there is a difference, it will be displayed next to the data point in the validation window with a number showing the difference between the retrieved value and the calculated value.

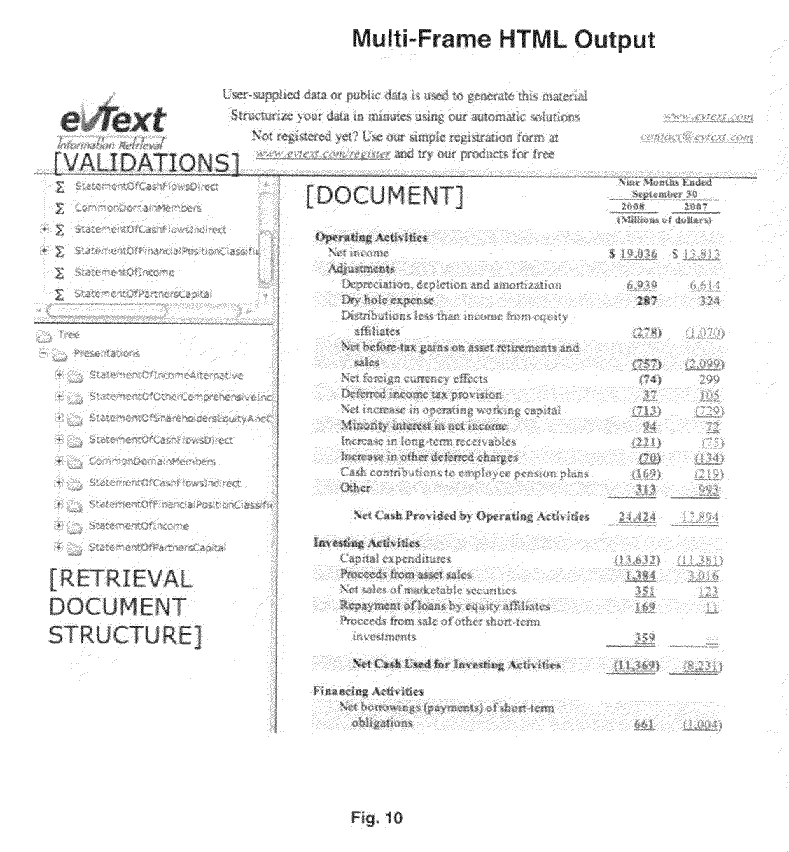

FIG. 10 The invention provides several different output formats through the results export feature (See FIG. 1₍₁₂₎. An XML format is one of them, and it gives the user an XML file with retrieved data attached to its data points. Another type of result, and its abstract, is shown in FIG. 9. It is a document in different formats:
PDF, HTML and MS Office, which contain the following:
An actual text with marked data points
A retrieval data structure with values attached to data points
A validator that indicates differences between retrieved data and calculations provided
Bidirectional links between data points in the retrieval data structure and the document
Bidirectional links between data points in the validator and the document

Such a document is self-contained; it doesn't require any additional links to the external resources or a database. It is good for:
Presentations
Storing data
Sharing results
Reviewing results
Analysis and validations

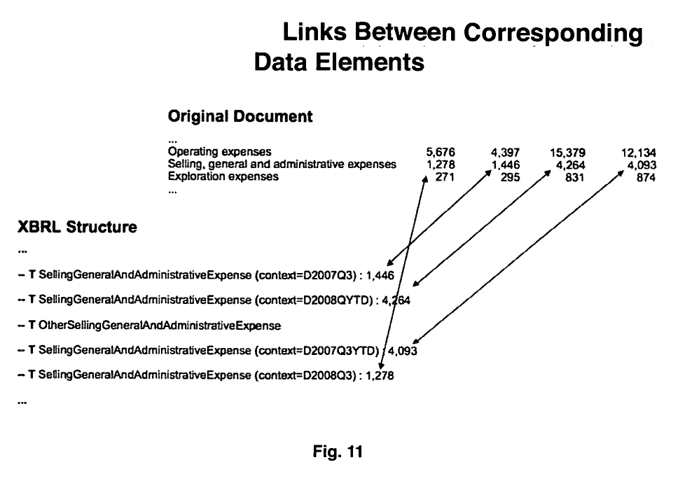

FIG. 11A bidirectional link between a document and a retrieval data structure saves time searching for retrieved data, and helps track the retrieved data for validations and comparisons with the original document. FIG. 11 indicates that every retrieved item in the retrieval data structure has a link to its original location in the document.

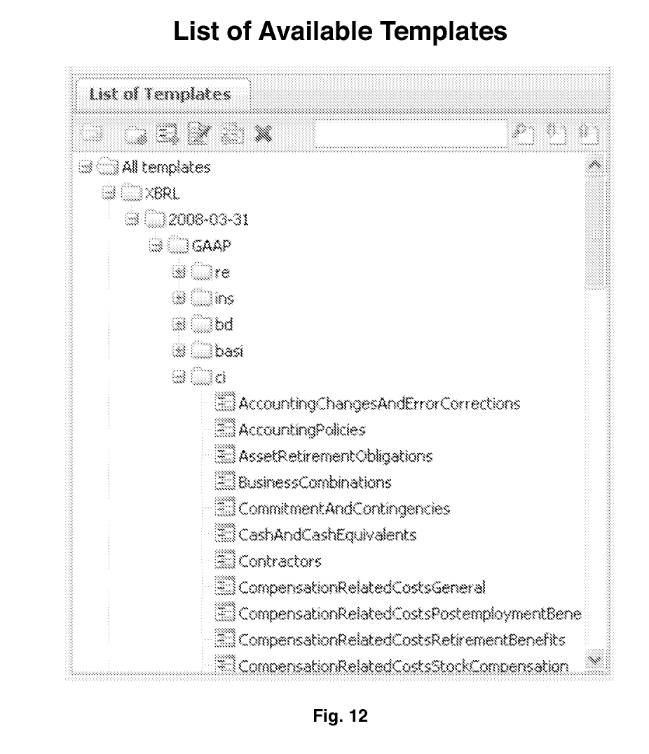

The illustration in FIG. 12 shows how the basic XBRL/IFRS taxonomy (See FIG. 1_{(8.4)}) is represented in the XBRL Data Mapping Builder. This approach is hereinafter represented as a Document Structure. Similar to other Document Structures, it is comprised of Branches and Data Points. The Data Mapping Builder allows the automatic generation of links between data points in the document and in the data structure for partially retrieved documents.

Branches help separate data points into logically related sets of data, or split data into different versions. Branches can't be linked to the data themselves, but the data points attached to them can.

The Retrieval Data Structure is an entity which helps to logically group data points and branches within a Statement or Disclosure.

Each version and type of the XBRL/IFRS data structure is represented as a separate branch in the retrieval data structure. For example, industries from the US_GAAP XBRL taxonomy are represented as “re”, “ins”, “bd”, “base” and “ci” branches. Each industry branch contains statements and disclosures, which are represented as a list of data structures.

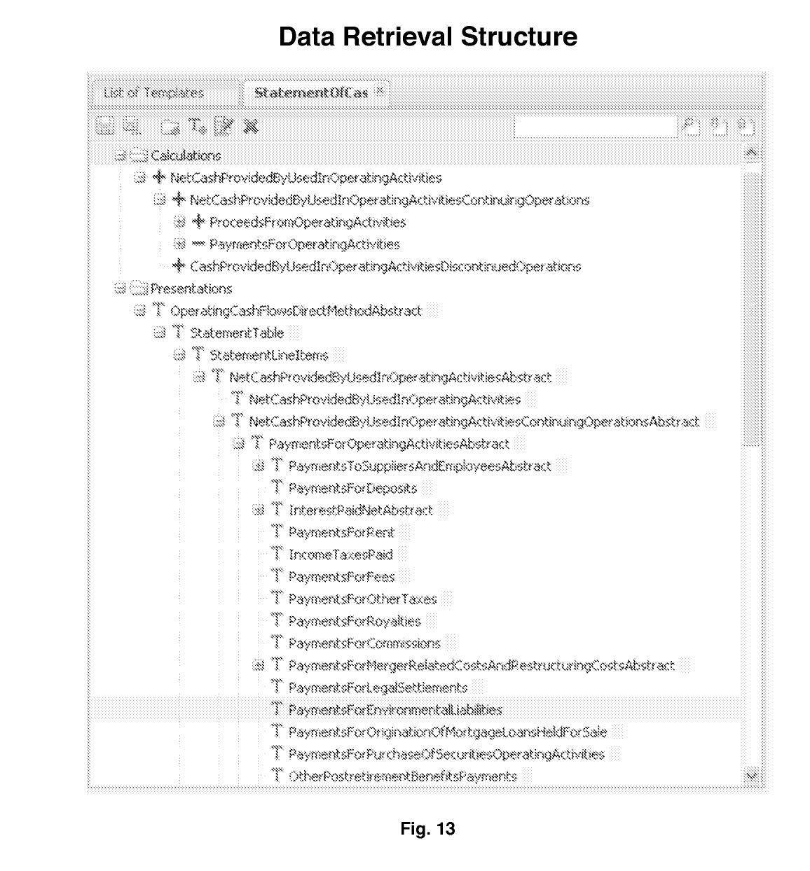

With reference to FIG. 13, an approach to how the XBRL/IFRS Statement is presented in the XBRL Data Mapping Builder is shown. XBRL/IFRS Statements and Disclosures are presented as data structures. Just like any retrieval data structure, XBRL and IFRS data structures are comprised of presentations and calculations.

A presentation introduces an element's structure of the XBRL/IFRS Statement. A Data Point's name is unique within one branch level.

Calculations introduce a set of formulas for validating data retrieved against the calculated values. This structure can contain combinations of links between the data points from the presentation part of data structure. Each link has a sign: Plus or Minus. Calculation structure is used during the validation process.

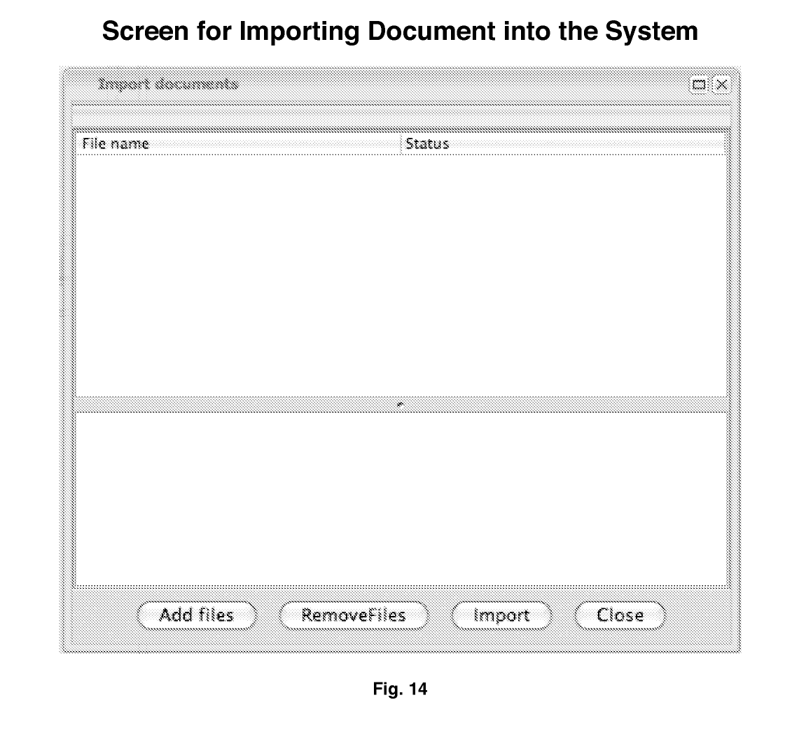

With reference to FIG. 14, a document's import process is illustrated. Any HTML file can be imported into the XBRL/IFRS Data Mapping Builder (See FIG. 1₍₄₎). In case the document is in another format (PDF, DOC, etc) the specific HTML-converter can be used.

A related retrieval data structure can be associated with a document during the document import process. However, it can be useful only for the manual retrieval process because the XBRL/IFRS Data Mapping procedure automatically sets up its own data retrieval structure.

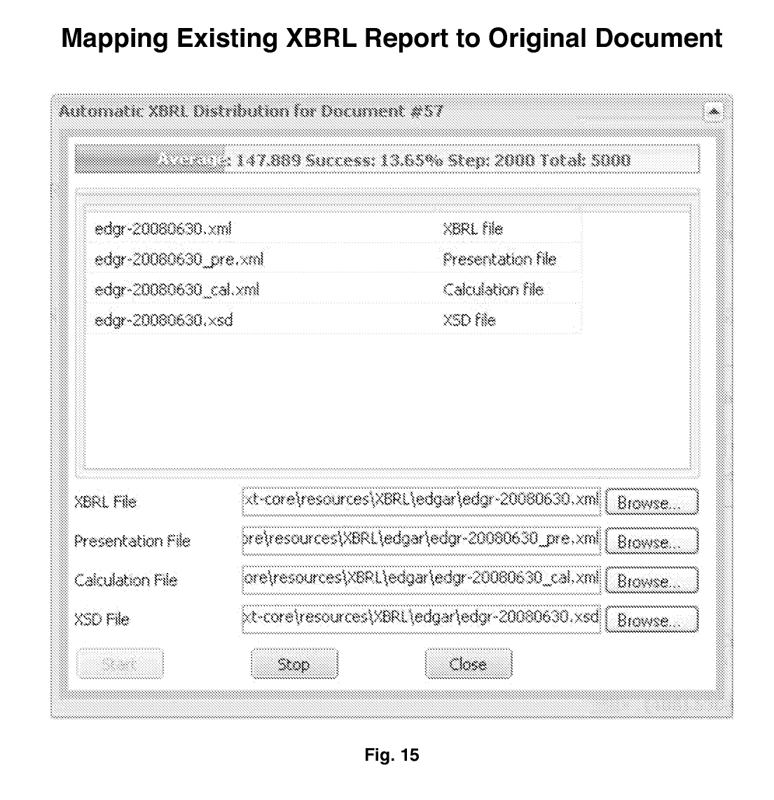

With reference to FIG. 15, the start of the XBRL/IFRS Data Mapping process is illustrated.

XBRL filing should be provided to start the process, comprising:
Instance document (XML file with retrieved data)
Schema document (XSD file with element's declaration)
Presentation extension (XML file with presentation extension)
Calculation extension (XML file with calculation extension)

The currently opened HTML document and selected XBRL filing are transmitted to the server for processing. Button Start starts the process. The progress bar on the top of the window shows the overall progress. The user can stop the process by pressing the Stop button. (the process mentioned is the same for other types of documents)

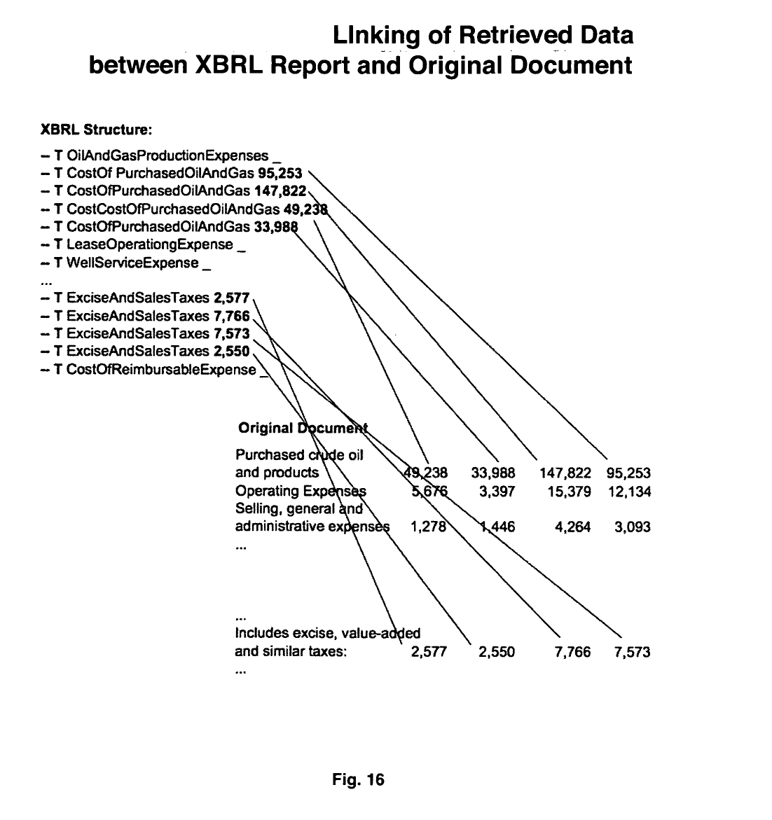

With reference to FIG. 16, the process of XBRL/IFRS Data Mapping connects already retrieved data with the HTML document. As a result, the user receives a data structure and the document linked at the data points which are already retrieved (left part at FIG. 16).

The presentation structure contains retrieved values, and these values are linked to the corresponding values in the document.

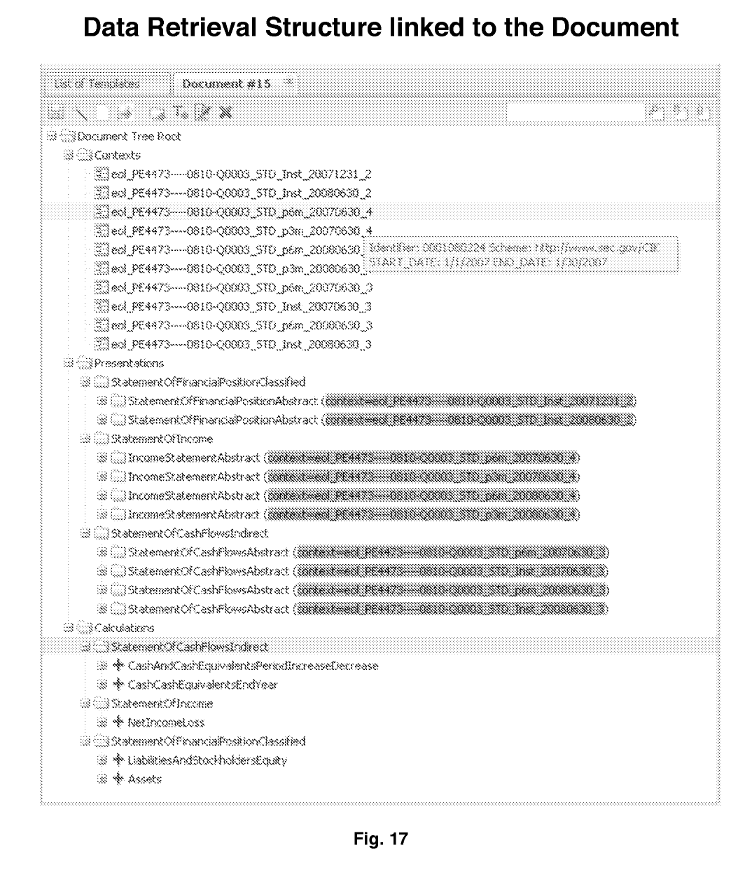

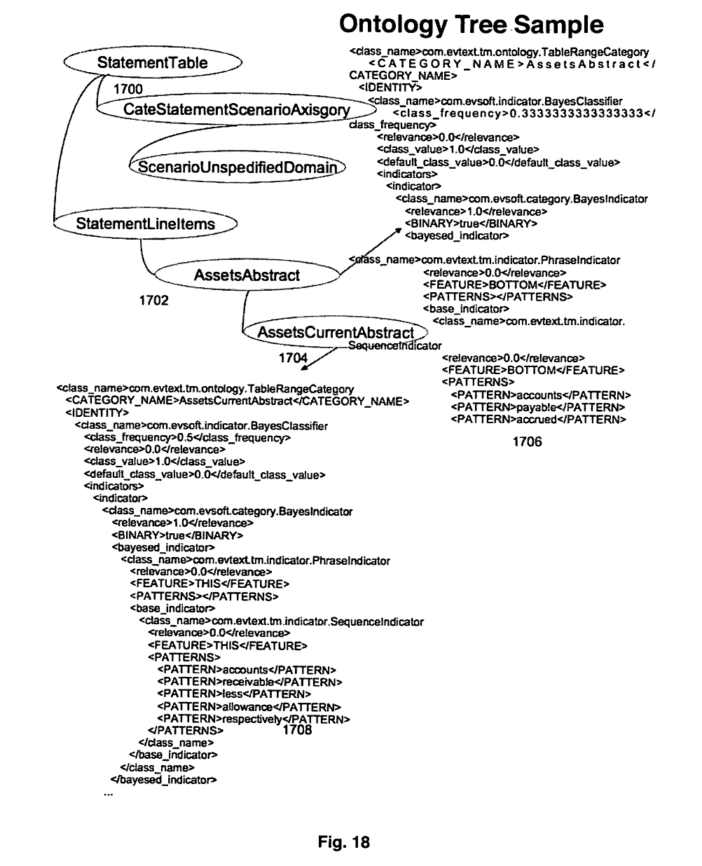

With reference to FIG. 17, a detailed document's structure with results of XBRL/IFRS Data Mapping is illustrated. The structure is comprised of:
Contexts
Calculations
Presentations

The contexts branch contains the list of contexts. Context is an entity and a form of report specific information (reporting period, segment information, etc) required by XBRL that allows the retrieved data to be understood in relation to other information. Context can be set up for the presentation branch or data point—which means this branch or term has the date from selected context.

The calculations branch contains the formula definition for this document. This formula is filled with data from the Presentations branch during the Validation (See FIG. 1₍₁₁₎) process, which occurs later.

The presentations branch contains retrieved statements segregated by contexts. In this example, contexts are the groups of dates and are presented as a table's column. In each statement, there are an equal number of sub-branches as there are of columns.

What is claimed is:

1. An automatic and manual process, system, workflow for data retrieval process, software, Web Site, service and SaaS (Software as a Service) created to support a data retrieval process from various document types to custom or preset retrieval data structures (taxonomy classification structures or schemas). It includes:
1. A system which supports manual and automatic data retrieval activities comprising:
a document repository capable of storing generic and user inserted documents linked to data holding structures
a collection of document converters for converting documents into HTML format for the import of documents into the system
a collection of template structures representing various document data views
a web interface providing full user access to data retrieval and contents management activities
a collection of multi-user controls and permission management tools
a text mining engine for automatic data retrieval
a collection of self-learning classification models for text object categories recognition
an output forms generator that converts the results of data retrieval into user defined formats
a set of background processes which supports the effectiveness of the data retrieval elements
a collection of pre-built generic ontologies for common standard data structures
a collection of preset calculations for validating retrieval results
a system for manually building calculations by the user
a set of tools for linking data points in the document, the retrieval data structure and validations

2. A system as claimed in claim 1, wherein:
said text mining engine for automatic data retrieval that uses an ontological model for text object categories representation. The engine uses an evolutionary search in ontologies for the most plausible data retrieval solution
a system as claimed in claim 1, wherein: said collection of self-learning classification models capable of retrieving dependencies between text object features and their position in ontology structure
a system as claimed in claim 1, wherein: said set of background processes supporting the effectiveness and integrity of text mining elements comprising:
search for the covering categories in existing ontologies
search for semantically correlated categories
automatic generation of selection specific classifiers
self-learning circle of automatic ontology and classifiers updates initiated by the user's
corrections of automatic retrieval results
automatic building of document type specific ontologies

3. A self-containing PDF, HTML or MS Office document occurs as a result of the data retrieval process comprising:
a. A taxonomy classification structure (a retrieval data structure) consisting of taxonomy units containing retrieved data;
b. An original document in correspondence to the type of document format with retrieved values highlighted in it;
c. A validation structure consisting of taxonomy units corresponding to the taxonomy classification structure units which indicate the differences between retrieved values and
values calculated using validation formulas;
d. The implementation of bidirectional links stored as special reference tags in HTML files and as a table of contents in the PDF documents and other types of documents between the original location of values in the documents and in the corresponding units of the taxonomy classification structures;

4. The implementation of bidirectional links between data units in the source document and
taxonomy classification structure storing retrieved data from the source document;

5. The implementation of web based SaaS (Software as a Service) for
a. Support of manual and automated data retrieval processes from users' documents;
b. Reuse of combined historical statistical data provided by the users for data retrieval improvement;
c. Reuse of results previously generated from manual retrieval processes or a retrieval process performed using other tools
d. Reuse of validation results previously generated by other validators
e. The ability to automatically establish links between documents, validations and taxonomy
classification structures generated before use of the invention
f. Effortless statistical model building without user involvement, based on the reuse of combined historical data
g. A full cycle of structured data retrieval drawn from standard practices of commonly used document types
